(19) United States
(12) Patent Application Publication
(10) Pub. No.: US 2010/0168333 A1
(43) Pub. Date: Jul. 1, 2010

(54) Thermoplastic Resin Having Excellent Heat Resistance and Impact Strength and Method of Preparing the Same

(75) Inventors: Jae Keun HONG, Uiwang-si (KR); Byeong Do LEE, Uiwang-si (KR); Ho Ryong SUN, Uiwang-si (KR); Young Sub JIN, Uiwang-si (KR); Hwan Seok PARK, Uiwang-si (KR); Sung Kwan KIM, Uiwang-si (KR); Sa Chun BAE, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/647,596

(22) Filed: Dec. 28, 2009

(30) Foreign Application Priority Data
Dec. 29, 2008 (KR) 2008-135514

(51) Int. Cl. C08L 51/04; C08L 33/24

(52) U.S. Cl. 525/73; 525/186

(57) ABSTRACT

The present invention provides a thermoplastic resin composition that can have excellent heat resistance and impact strength comprising a rubber-modified styrene resin and a copolymer of N-substituted maleimide compound and aromatic vinyl compound.

### CROSS REFERENCE TO RELATED APPLICATIONS

This application claims priority from Korean Patent Application No. 2008-135514, filed Dec. 29, 2008 in the Korean Intellectual Property Office, the disclosure of which is incorporated herein by reference in its entirety.

### FIELD OF THE INVENTION

The present invention relates to a thermoplastic resin and a method of preparing the same.

### BACKGROUND OF THE INVENTION

Generally, acrylonitrile-butadiene-styrene (ABS) copolymer resins have excellent molding properties as well as excellent impact resistance, chemical resistance, physical strength and the like. Accordingly, ABS resins may be widely used in a variety of products such as electrical/electronic appliances and automobile parts. However, the use of ABS resins is limited in applications requiring high heat resistance, because ABS resins have low heat resistance.

A commonly used method to improve the heat resistance of ABS resins includes melt extrusion of the ABS resin with a heat resistant copolymer resin. The heat resistant copolymer resin can be prepared using α-methylstyrene (AMS) or N-phenyl maleimide (PMI).

For example, a heat resistant ABS resin can be prepared using a liquid AMS monomer. This method has the benefit of low material costs and ease of handling the materials, as compared to methods using a PMI monomer in powder form.

However, it is difficult to prepare a product having both high heat resistance and high impact strength in a continuous ABS polymerization process at high temperatures using an AMS monomer because the AMS monomer can self-depolymerize. During phase inversion polymerization of the rubber and matrix material or polymerization after phase inversion, the polymer melt is continuously exposed to a temperature above which PAMS is depolymerized. This in turn can reduce the molecular weight of the polymer and/or destabilize the rubber.

### SUMMARY OF THE INVENTION

The present invention provides a thermoplastic resin which can have excellent heat resistance and a method of preparing the same.

The present invention also provides a thermoplastic resin which can have both excellent heat resistance and impact strength, and a method of preparing the same.

The present invention also provides a preparation method which can improve heat resistance as well as maintain physical properties of a thermoplastic resin.

The thermoplastic resin of the present invention may comprise a rubber-modified styrene resin and a copolymer of N-substituted maleimide compound and aromatic vinyl compound. The copolymer of N-substituted maleimide compound and aromatic vinyl compound may be prepared by copolymerizing about 40 to about 60% by weight of the N-substituted maleimide compound and about 40 to about 60% by weight of the aromatic vinyl compound.

The thermoplastic resin of the invention can be prepared by adding and mixing the copolymer of N-substituted maleimide compound and aromatic vinyl compound with reactants used to prepare the rubber-modified styrene resin, and all of the reactants can be continuously polymerized to form the rubber-modified styrene resin. For example, the copolymer of N-substituted maleimide compound and aromatic vinyl compound can be melted in an unsaturated nitrile compound and then added and mixed with other reactants in a process of continuously polymerizing the rubber-modified styrene resin.

The rubber-modified styrene resin may comprise a graft copolymer resin prepared by graft copolymerizing an aromatic vinyl monomer and an unsaturated nitrile monomer onto a rubbery polymer, and a copolymer resin prepared by copolymerizing an aromatic vinyl monomer, an unsaturated nitrile monomer and a heat resistant aromatic vinyl monomer.

The rubbery polymer may comprise a conjugated diene rubber and a rubbery aromatic copolymer.

The rubber-modified styrene resin may further comprise a multi-functional vinyl monomer.

The thermoplastic resin may have a weight average molecular weight of about 100,000 to about 150,000 and a polydispersity index of about 2 to about 4. Moreover, the thermoplastic resin may have an Izod impact strength of about 15 to about 35 (kgf·cm/cm, ⅛″ Notched) measured according to ASTM D256, a melt flow index of about 3 to about 7 (220° C., 10 kg) measured according to ASTM D1238, and a vicat softening temperature of about 107 to about 115° C. (5 kg, 50°/hr) measured according to ISO R 306.

A method according to an exemplary embodiment of the present invention may comprise polymerizing a first reactant including conjugated diene rubber, aromatic rubbery copolymer, heat resistant aromatic vinyl compound, aromatic vinyl compound, multi-functional vinyl compound and initiator, and a second reactant including unsaturated nitrite compound, N-substituted maleimide compound and aromatic vinyl compound in a plurality of reactors linked in series after continuously introducing the first and second reactants into one of the plurality of reactors (which can be the same or different reactors) through different feeding streams. The number of the plural reactors can be about 2 to about 5.

In an embodiment of the present invention, the first reactant and the second reactant may be directed into the same reactor and polymerized.

In another embodiment of the present invention, the first reactant and the second reactant may be directed into different reactors. For example, the first reactant may be fed into a first reactor and polymerization thereof can be initiated. Thereafter polymer from the first reactor can be transferred to another reactor in the series (for ease of reference, to a “second” reactor). The second reactant may then participate in a downstream polymerization reaction by feeding the second reactant to the second reactor downstream of the first reactor.

In an exemplary embodiment of the present invention, the temperature of each reactor may be maintained at about 90 to about 150° C., and a final polymerization reactor of the plural reactors can be maintained at a temperature of about 110 to about 140° C.

In another embodiment of the present invention, the method may further comprise delivering the polymer to a devolatizer apparatus and removing residual or remaining unreacted reactants and/or volatile components. The polymer is delivered to the devolatizer at a temperature of about 140 to about 160° C. The devolatizer apparatus may be operated under the conditions of a temperature of about 230 to about 260° C. and a pressure of about 100 torr or less.

The present invention now will be described more fully hereinafter in the following detailed description of the invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein the term “and/or” includes any and all combinations of one or more of the associated listed items. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A thermoplastic resin composition of the present invention may comprise a rubber-modified styrene resin and a copolymer of N-substituted maleimide compound and aromatic vinyl compound. The thermoplastic resin composition according to the present invention may include about 100 parts by weight of the rubber-modified styrene resin and about 1 to about 14.3 parts by weight of the copolymer of N-substituted maleimide compound and aromatic vinyl compound, based on about 100 parts by weight of the rubber-modified styrene resin.

The thermoplastic resin composition according to the present invention may have both excellent heat resistance and excellent impact strength.

In one embodiment of the present invention, the rubber-modified styrene resin may comprise a graft copolymer resin prepared by graft copolymerizing an aromatic vinyl monomer and an unsaturated nitrile monomer onto a rubbery polymer, and a copolymer resin prepared by copolymerizing an aromatic vinyl monomer, an unsaturated nitrile monomer and a heat resistant aromatic vinyl monomer.

The rubbery polymer may include a conjugated diene rubber and a rubbery aromatic copolymer.

The heat resistant aromatic vinyl monomer may include α-methyl styrene.

In an exemplary embodiment of the present invention, the rubber-modified styrene resin may comprise about 5 to about 20% by weight of the conjugated diene rubber (A), about 0.5 to about 8% by weight of the aromatic rubbery copolymer (B), about 15 to about 29% by weight of the heat resistant aromatic vinyl monomer (C), about 10 to about 50% by weight of the aromatic vinyl monomer (D) and about 10 to about 30% by weight of the unsaturated nitrile monomer (E), based on the total weight of the rubber-modified styrene resin. As another example, the rubber-modified styrene resin may comprise about 7 to about 15% by weight of the conjugated diene rubber (A), about 1 to about 5% by weight of the aromatic rubbery copolymer (B), about 18 to about 27% by weight of heat resistant aromatic vinyl monomer (C), about 20 to about 45% by weight of aromatic vinyl monomer (D) and about 15 to about 25% by weight of unsaturated nitrile monomer (E), based on the total weight of the rubber modified styrene resin.

In another embodiment of the present invention, the rubber-modified styrene resin can further comprise a multi-functional vinyl monomer (F). For example, the rubber-modified styrene resin can include the multi-functional vinyl monomer (F) in an amount of about 0.005 to about 0.29 parts by weight, based on about 100 parts by weight of the rubber-modified styrene resin excluding the multi-functional vinyl monomer.

The multi-functional vinyl monomer may include divinyl benzene.

The thermoplastic resin composition according to the present invention can be prepared by adding a solution phase of the copolymer of N-substituted maleimide compound and aromatic vinyl compound during continuous polymerization of the rubber-modified styrene resin. The solution phase of the copolymer of N-substituted maleimide compound and aromatic vinyl compound may be prepared by melting the copolymer of N-substituted maleimide compound and aromatic vinyl compound in an unsaturated nitrile compound.

In another embodiment of the present invention, polymerization reactants used to prepare the rubber-modified styrene resin by the continuous polymerization process may comprise the conjugated diene rubber (A), the aromatic rubbery copolymer (B), the heat resistant aromatic vinyl monomer (C), the aromatic vinyl monomer (D), the unsaturated nitrile monomer (E) and organic solvent (I).

The thermoplastic resin may have a weight average molecular weight of about 100,000 to about 150,000 and a polydispersity index measured according to LF-804 column (Waters) through GPC of about 2 to about 4, for example, about 2.2 to about 3.5.

The thermoplastic resin composition having heat resistance and impact strength can be prepared by following method.

A first reactant may be prepared by mixing conjugated diene rubber (A), aromatic rubbery copolymer (B), heat resistant aromatic vinyl compound (C), aromatic vinyl compound (D), multi-functional vinyl compound (F) and initiator (H). The first reactant can comprise conjugated diene rubber (A), aromatic rubbery copolymer (B), heat resistant aromatic vinyl compound (C), aromatic vinyl compound (D), multi-functional vinyl compound (F), initiator (H) and organic solvent (I).

A second reactant may be prepared by melting copolymer (G) of N-substituted maleimide compound and aromatic vinyl compound into unsaturated nitrile compound (E).

A polymer may be prepared by continuously feeding and polymerizing the first reactant and the second reactant through different feeding streams into plural reactors linked in series.

For example, the first reactant may be supplied through a main feeding stream linked to a reactor in the series, and the second reactant may be supplied through a side feeding stream which is different from the main feeding stream to the same or a different reactor in the series.

The copolymer (G) of N-substituted maleimide compound and aromatic vinyl compound may be melted in the unsaturated nitrile compound (F). However, when the copolymer (G) is mixed with other reactants, it cannot melt. Moreover, the amount of copolymer (G) of N-substituted maleimide compound and aromatic vinyl compound can be controlled easily during the polymerization reaction by controlling the flux of the second reactant by feeding the first reactant and the second reactant through different feeding streams. Therefore, reduction of physical properties such as impact strength can be prevented by reducing the difference in miscibility between the graft polymer resin including rubber and a matrix resin.

The first reactant and the second reactant can be fed into the same reactor, or the first reactant and the second reactant can be fed into different reactors.

For example, the first reactant may be fed into a first reactor in a series of plural reactors, and the polymerization reaction may be initiated by the initiator included in the first reactant.

The second reactant may be reacted with the first reactant during the initial polymerization reaction by feeding the second reactant into the first reactor. Alternatively, the second reactant can participate in the polymerization reaction after the polymerization has progressed above a certain point (i.e. after reaching the desired degree of polymerization) by feeding the second reactant into a reactor downstream from the first reactor, for example, one of the final reactors where the polymerization reaction is finished.

The molecular weight and physical properties of the thermoplastic resin can be controlled by feeding the second reactant into different ones of the reactors. For example, if the second reactant is fed into the first reactor in the series of plural reactors with the first reactant and is reacted with the first reactant during the initial polymerization reaction in the first reactor, the thermoplastic resin can have a relatively high molecular weight. If the second reactant is fed to a reactor downstream of the first reactor, however, where it can participate in the continuous polymerization of polymer transferred thereto from an upstream reactor, the molecular weight of the thermoplastic resin can have a relatively lower molecular weight.

The number of the plural reactors in series can be about 2 to about 5.

In an exemplary embodiment of the present invention, various reaction conditions and variables such as feed rate, reaction temperature, residence time, and the type and amount of an initiator added to the reactant can be constantly controlled to maintain a desired polymerization rate within each reactor. The skilled artisan will appreciate and understand exemplary reaction conditions and variables suitable for use in the present invention, which can be in accordance with conventional conditions and variables, without undue experimentation.

The temperatures of each reactor may be maintained at about 90 to about 150° C., for example about 110 to about 140° C., although the temperature of the final polymerization reactor of the plural reactors can be maintained at a temperature of about 110 to about 140° C. If temperature of the final reactor is less than about 110° C., economical efficiency can be reduced due to low production yield and energy can be wasted in a devolatizer apparatus. If the temperature of the final reactor is higher than about 140° C., it may be difficult to achieve the desired heat resistance due to the low molecular weight of the resultant resin.

In an exemplary embodiment of the present invention, the polymer can be prepared by a continuous polymerization process in a plurality of reactors, and thereafter the process can further include the steps of delivering the prepared polymer to a devolatizer apparatus and removing residual or remaining unreacted reactants and/or volatile components.

When the polymer is feed from the final reactor to a devolatizer apparatus, the temperature of the polymer may be maintained at a temperature of about 140 to 160° C. Generally, the polymer may be delivered by a pipe connecting the reactor and the devolatizer apparatus. If the temperature of the polymer is less than about 140° C. in the delivering process, it can be difficult to effectively transfer the polymer melt to the devolatizer apparatus. If the temperature of the polymer is more than about 160° C., the polymer may not have the desired heat resistance and impact strength due to low molecular weight resulting from depolymerization of the heat resistant aromatic vinyl compound (C).

The devolatizer apparatus may be operated under the conditions of a temperature of about 230 to about 260° C. and a pressure of about 100 torr or less. If the temperature of the devolatizer apparatus is less than about 230° C. and the pressure of the devolatizer apparatus is higher than about 100 torr, impact strength and color property of the final thermoplastic resin product can be reduced because volatile components remaining in the polymer may not be sufficiently removed. If the temperature of the devolatizer apparatus is higher than about 260° C., color property can be reduced because the polymer may be carbonized.

In another embodiment of the present invention, the first reactant further comprises an organic solvent.

Each component of the polycarbonate resin composition of the present invention now will be described more fully hereinafter in the following detailed description of the invention.

(A) Conjugated Diene Rubber

A polymer or a copolymer of conjugated diene compound which has about 4 to about 12 carbons may be used as the conjugated diene rubber (A). For example, the conjugated diene compound may have about 4 to about 8 carbons. Exemplary conjugated diene compounds that can be used to prepare the conjugated diene rubber (A) may include without limitation 1,3-butadiene, 2-methyl-1,3-butadiene(isoprene), 2-ethyl-1,3-butadiene, 2,3-dimethyl-1,3-butadiene, 1,3-pentadiene, 3-butyl-1,3-oxtadiene, and the like and combinations thereof. For example the conjugated diene compound can be 1,3-butadiene, isoprene, or a combination thereof.

In an exemplary embodiment of the present invention, the butadiene may be used as a solution of about 5% by weight butadiene in styrene (prepared by melting the conjugated diene rubber (A) in styrene), which solution may have a viscosity of about 40 to about 80 cps at 25° C.

If the viscosity is less than about 40 cps, the desired low gloss property may not be accomplished because rubber particles may be too small. If the viscosity is higher than about 80 cps, impact strength may be low because the rubber particles of the final product may be too large.

The conjugated diene rubber (A) may be used in an amount of about 5 to about 20% by weight, for example about 7 to about 15% by weight, based on the total weight of the reactants used to prepare thermoplastic resin. If the amount of the conjugated diene rubber (A) is less than about 5% by weight, the desired high impact strength may not be achieved, and if the amount of the conjugated diene rubber (A) is more than about 20% by weight, the desired excellent heat resistance may not be achieved because heat resistance may be significantly reduced.

(B) Rubbery Aromatic Copolymer

In an exemplary embodiment of the present invention, a copolymer of conjugated diene compound and aromatic vinyl compound may be used as the rubbery aromatic copolymer (B). The rubbery aromatic copolymer (B) may be prepared by copolymerizing about 50 to about 80% by weight of a conjugated diene compound and about 20 to about 50% by weight of an aromatic vinyl compound.

Exemplary conjugated diene compounds may include without limitation 1,3-butadiene, 2-methyl-1,3-butadiene, 2-ethyl-1,3-butadiene, 2,3-dimethyl-1,3-butadiene, 1,3-pentadiene, 3-butyl-1,3-octadiene, and the like, and combinations thereof, for example, 1,3-butadiene.

The aromatic vinyl compound used to prepare the rubbery aromatic copolymer (B) may be used in an amount range of about 20 to about 50% by weight, for example about 25 to about 35% by weight, based on about 100% by weight of the rubbery aromatic copolymer (B). If the amount of the aromatic vinyl compound is less than about 20% by weight, it may be difficult to control the balance of physical properties such as low gloss property and impact strength because the aromatic vinyl compound may not play the role of reducing cohesion of particles of the simultaneously used conjugated diene compound. If the amount of the aromatic vinyl compound is more than about 50% by weight, the desired impact strength may not be accomplished because the amount of the rubbery component may be reduced.

Exemplary aromatic vinyl compounds may include without limitation styrene, α-methyl styrene, 2-methyl styrene, 3-methyl styrene, 4-methyl styrene, 2-ethyl styrene, 3-ethyl styrene, 4-ethyl styrene, 4-n-bytyl styrene, 1-vinyl naphthalene, 2-vinyl naphthalene and the like and combinations thereof.

In an embodiment of the present invention, the aromatic rubbery copolymer (B) can be a tapered copolymer (rubber component-unsaturated monomer), a linear copolymer, a di-block copolymer, a tri-block copolymer, or a combination thereof.

The method of preparing the aromatic rubbery copolymer (B) will be readily understood by one skilled in the art. The aromatic rubbery copolymer (B) used in the present invention is commercially available, including products available from Asahi Kasei Chemical Corporation, Kumho Petrochemical, Chevron-phillips, Kraton, and Atofina.

In an embodiment of the present invention, the aromatic rubbery copolymer (B) may used in an amount of about 0.5 to about 8% by weight, for example about 1 to about 5% by weight, based on the total weight of the reactants. If the amount of the aromatic rubbery copolymer (B) is less than about 0.5% by weight, it may be difficult to achieve the desired balance between low gloss property and high impact strength because it can be difficult to prepare rubber particles having a stable rubber morphology. If the amount of the aromatic rubbery copolymer (B) is more than about 8% by weight, the desired impact resistance may not be obtained.

(C) Heat Resistant Aromatic Vinyl Compound

In an embodiment of the present invention, an aromatic vinyl compound having a structure for improving heat resistance may be used as the heat resistant aromatic vinyl compound (C), for example, α-methyl styrene.

The heat resistant aromatic vinyl compound (C) may used in an amount of about 15 to about 29% by weight, for example about 18 to about 27% by weight, and as another example about 19 to about 25% by weight, based on total weight of the reactants. If the amount of the heat resistant aromatic vinyl compound (C) is less than about 15% by weight, it may be difficult to achieve the desired high heat resistance, and if the amount of the heat resistant aromatic vinyl compound (C) is more than about 29% by weight, it may be difficult to achieve both desired impact strength and heat resistance because the molecular weight of the polymer can be significantly reduced during the polymerizing process.

(D) Aromatic Vinyl Compound

Exemplary aromatic vinyl compounds (D) used in the present invention may include without limitation styrene, 2-methyl styrene, 3-methyl styrene, 4-methyl styrene, 2-ethyl styrene, 3-ethyl styrene, 4-ethyl styrene, 4-n-propyl styrene, 4-t-butyl styrene, 1-vinyl naphthalene, 2-vinyl naphthalene, vinyl toluene and the like, and combinations thereof. The aromatic vinyl compound (D) may used in an amount of about 10 to about 50% by weight, for example about 15 to about 45% by weight, and as another example about 20 to about 43% by weight, based on the total weight of the reactants, depending on the desired properties of the final product.

(E) Unsaturated Nitrile Compound

Exemplary unsaturated nitrile compounds (E) includes without limitation acrylonitrile, methacrylonitrile, and the like, and combinations thereof. The unsaturated nitrile compound (E) may be used in an amount of about 10 to about 30% by weight, for example about 13 to about 25% by weight, and as another example about 15 to about 20% by weight, based on the total weight of the reactants, and can vary depending on the desired properties of the final product.

(F) Multi-Functional Vinyl Compound

Exemplary multi-functional vinyl compounds (F) may include without limitation divinylbenzene, ethylene glycol dimethacrylate, allyl methacrylate, diallyl phthalate, diallyl maleate, triallylisocyanurate, and the like and combinations thereof.

The multi-functional vinyl compound (F) may be used in an amount of about 0.005 to about 0.5 parts by weight, for example, about 0.01 to about 0.15 parts by weight, and as another example about 0.05 to about 0.1 parts by weight, based on about 100 parts by weight of (A)+(B)+(C)+(D)+(E)+(I). If the amount of the multi-functional vinyl compound (F) is less than about 0.005 parts by weight, impact strength and heat resistance may not be improved due to the effect of improving molecular weight. If the amount of the multi-functional vinyl compound (F) is more than about 0.2 parts by weight, the polymerization reaction may be unstable and rubber gel can be appeared.

The multi-functional vinyl compound (F) may function as a cross linking agent in the rubber-modified styrene resin of the thermoplastic resin of the present invention. As the amount of the multi-functional vinyl compound (F) is increased, it can affect the polydispersity index of the thermoplastic resin composition. The polydispersity index measured according to LF-804 column (Waters) may be obtained by obtaining elution curves of samples including THF as a moving phase through GPC and charted on the basis of standard polystyrene polymer.

For example, the polydispersity index of the thermoplastic resin of the present invention may be about 2 to about 4, for example about 2.2 to about 3.5.

(G) Copolymer of N-Maleimide Compound and Aromatic Vinyl Compound

The copolymer of N-maleimide compound and aromatic vinyl compound may be prepared by copolymerizing about 40 to about 60% by weight of N-maleimide compound and about 40 to about 60% by weight of aromatic vinyl compound. The copolymer of N-maleimide compound and aromatic vinyl compound can be prepared by known methods such as emulsion polymerization, suspension polymerization, solution polymerization, or bulk polymerization.

For example, the copolymer of N-maleimide compound and aromatic vinyl compound may be prepared by copolymerizing the aromatic vinyl compound and maleic anhydride and thereafter substituting the oxygen atom at the center of maleic anhydride to form an N-substituted imide group.

Exemplary N-maleimide compounds may include without limitation N-phenyl maleimide. Exemplary aromatic vinyl compounds may include without limitation styrene, 2-methyl styrene, 3-methyl styrene, 4-methyl styrene, 2-butyl styrene, 1-vinyl naphthalene, vinyl toluene and the like, and combinations thereof.

The copolymer (G) of N-maleimide compound and aromatic vinyl compound may be used in an amount of about 1 to about 10 parts by weight, for example about 1 to about 7 parts by weight, and as another example about 2 to about 5 parts by weight, based on about 100 parts by weight of (A)+(B)+(C)+(D)+(E)+(I). If the amount of the copolymer (G) of N-maleimide compound and aromatic vinyl compound is less than about 1 part, the desired heat resistance may not be obtained. If the amount of the copolymer (G) of N-maleimide compound and aromatic vinyl compound is more about than 10 parts, physical properties such as impact strength may be reduced, and sufficient heat resistance may not result because the copolymer (G) of N-maleimide compound and aromatic vinyl compound may not be sufficiently melted into unsaturated nitrile compound.

(H) Initiator

Exemplary initiators may include without limitation benzoyl peroxide, t-butyl peroxyisobutyrate, 1,1-bis(t-butylperoxy)cyclohexane, 2,2-bis(4,4-di-t-butylperoxy cyclohexane)propane, t-hexyl peroxy isopropyl monocarbonate, t-butyl peroxylaurate, t-butyl peroxy isopropyl monocarbonate, t-butyl peroxy 2-ethylhexyl monocarbonate, t-hexyl peroxybenzoate, t-butyl peroxyacetate, 2,2-bis(t-butyl peroxy)butane, t-butyl peroxybenzoate, dicumyl peroxide, 2,5-dimethyl-2,5-bis(t-butyl peroxy)hexane, t-butyl cumyl peroxide, di-t-butyl peroxide, di-t-amyl peroxide and the like, and combinations thereof.

The initiator (H) may be used in an amount of about 0.01 to about 0.5 parts by weight, for example about 0.04 to about 0.1 parts by weight, based on about 100 parts by weight of (A)+(B)+(C)+(D)+(E)+(I). If the initiator is used in an amount of more than about 0.5, it may be difficult to control reaction time and residual temperature because of too rapid polymerization, or impact strength may be reduced because the polymer may have a lower molecular weight. If the initiator is used in an amount of less than about 0.01, the desired conversion ratio may not be reached due to significantly reduced reaction rate.

(I) Organic Solvent

The present invention optionally can further comprise an organic solvent (I). The organic solvent (I) may be inactive (inert) to a polymerizing reaction and can dissolve both reactant and polymer. Exemplary solvents include without limitation alcohols, aromatic hydrocarbons such as petroleum ether and ethyl benzene, halides such as carbon tetrachloride and chloroform, ketones such as methylethyl ketone, and the like, and combinations thereof. The organic solvent (I) may be used in an amount of about 0 to about 30% by weight, for example about 5 to about 20% by weight, and as another example about 10 to about 25% by weight, based on total weight of reactants.

The invention may be better understood by reference to the following examples which are intended for the purpose of illustration and are not to be construed as in any way limiting the scope of the present invention, which is defined in the claims appended hereto.

### EXAMPLES

### Example 1

8 parts by weight of a 5% by weight solution of butadiene rubber in styrene (ASAPRENE 700A; Asahi Kasei Chemical Corporation) having a solution viscosity of 45 cps and 2 parts by weight of a 5% by weight solution of styrene-butadiene rubber in styrene (ASAPRENE 670A; Asahi Kasei Chemical Corporation) having a solution viscosity of 40 cps and comprising 39% by weight of styrene are melted into a solution comprising 20.25 parts by weight of α-methyl styrene, 36.75 parts by weight of styrene and 15 parts by weight of ethylbenzene solvent, and 0.045 parts by weight of 1,1-bis(t-butylperoxy)cyclohexane as initiator and 0.05 parts by weight of divinyl benzene are added to prepare the first reactant. The prepared first reactant is injected into a first reactor (R1) through a main feeding stream at a rate of 19.95 kg/hr.

A second reactant is prepared in which 2 parts by weight of a copolymer of N-substituted maleimide compound and aromatic vinyl compound (MS-NA (PMI 50%); DENKA Corporation) is melted into 18 parts by weight of acrylonitrile and the second reactant is simultaneously fed into the first reactor through a sub-feeding stream at a rate of 5.05 kg/hr.

The first reactor (R1) is controlled at a polymerizing temperature of 110° C., a screw-rotating speed of 120 rpm, and a rate of polymerization of 25%. The resultant polymer from the first reactor is fed to a second reactor (R2) which is controlled at a polymerizing temperature of 121° C., a screw-rotating speed of 100 rpm, and a rate of polymerization of 46%. The resultant polymer from the second reactor is fed to a third reactor (R3) which is controlled at a polymerizing temperature of 130° C., a screw-rotating speed of 60 rpm, and a rate of polymerization of 68% to prepare a polymer.

The polymer is delivered as a polymer melt at 160° C. via a pipe delivering polymer to a devolatizer and zapper. The devolatizer removes residual or remaining reactants and/or volatile components and a thermoplastic resin is prepared in the form of pellets.

### Example 2

The preparation process is carried out using the same method as preparation Example 1 except that a second reactant in which 5 parts by weight of the copolymer of N-substituted maleimide compound and aromatic vinyl compound (MS-NA (PMI 50%); DENKA Corporation) is melted into 18 parts by weight of acrylonitrile is fed into the first reactor through a sub-feeding stream at a rate of 5.63 kg/hr.

### Example 3

The preparation process is carried out using the same method as preparation Example 1 except that after melting 8 parts by weight of butadiene rubber and 2 parts by weight of styrene-butadiene copolymer into a solution comprising 20.25 parts by weight of α-methyl styrene, 36.75 parts by weight of styrene, 15 parts by weight of ethylbenzene solvent and 9 parts by weight of acrylonitrile, 0.045 parts by weight of 1,1-bis(t-butylperoxy)cyclohexane as initiator and 0.05 parts by weight of divinyl benzene to prepare the first reactant, the prepared first reactant is injected into the first reactor (R1) through a main feeding stream at a rate of 23.31 kg/hr, and the second reactant in which 2 parts by weight of the copolymer of N-substituted maleimide compound and aromatic vinyl compound (MS-NA (PMI 50%); DENKA Corporation) is melted into 9 parts by weight of acrylonitrile is fed into the third reactor (R3) through a sub-feeding stream at a rate of 1.69 kg/hr.

### Comparative Example 1

The preparation process is carried out using the same method as Preparation Example 1 except that a second reactant in which 2 parts by weight of N-phenyl maleimide (PMI) instead of the copolymer of N-substituted maleimide compound and aromatic vinyl compound is melted into 18 parts by weight of acrylonitrile is fed into the first reactor through a sub-feeding stream at a rate of 5.05 kg/hr.

### Comparative Example 2

The preparation process is carried out using the same method as Preparation Example 1 except that a second reactant in which 5 parts by weight of N-phenyl maleimide (PMI) instead of the copolymer of N-substituted maleimide compound and aromatic vinyl compound is melted into 18 parts by weight of acrylonitrile is fed into the first reactor through a sub-feeding stream at a rate of 5.63 kg/hr.

### Comparative Example 3

The preparation process is carried out using the same method as Preparation Example 1 except that 11.25 parts by weight of α-methyl styrene and 45 parts by weight of styrene are used as monomers, and the second reactant is prepared using 18.75 parts by weight of acrylonitrile instead of the copolymer of N-substituted maleimide compound and aromatic vinyl compound.

### Comparative Example 4

The preparation process is carried out using the same method as Preparation Example 1 except that 20.25 parts by weight of α-methyl styrene and 36 parts by weight of styrene are used as monomers, and the second reactant is prepared using 18.75 parts by weight of acrylonitrile instead of the copolymer of N-substituted maleimide compound and aromatic vinyl compound.

### Comparative Example 5

The preparation process is carried out using the same method as Preparation Example 1 except that 30 parts by weight of α-methyl styrene and 26.25 parts by weight of styrene are used as monomers, and the second reactant is prepared using 18 parts by weight of acrylonitrile instead of the copolymer of N-substituted maleimide compound and aromatic vinyl compound.

The respective foregoing components in the amounts of Examples 1 to 3 and Comparative Examples 1 to 5 are represented in the following Table 1.

TABLE 1

| | | | | Comparative | Comparative | Comparative | Comparative | Comparative |
|---|---|---|---|---|---|---|---|---|
| | Example 1 | Example 2 | Example 3 | Example 1 | Example 2 | Example 3 | Example 4 | Example 5 |
| (A) | 8 | 8 | 8 | 8 | 8 | 8 | 8 | 8 |
| (B) | 2 | 2 | 2 | 2 | 2 | 2 | 2 | 2 |
| (C) | 20.25 | 20.25 | 20.25 | 20.25 | 20.25 | 11.25 | 20.25 | 30 |
| (D) | 36.75 | 36.75 | 36.75 | 36.75 | 36.75 | 45 | 36 | 26.25 |
| (E) | 18 | 18 | 18 | 18 | 18 | 18.75 | 18.75 | 18.75 |
| (F) | 0.05 | 0.05 | 0.05 | 0.05 | 0.05 | 0.05 | 0.05 | 0.05 |
| (G) | 2 | 5 | 2 | — | — | — | — | — |
| (H) | 0.045 | 0.045 | 0.045 | 0.045 | 0.045 | 0.045 | 0.045 | 0.045 |
| (I) | 15 | 15 | 15 | 15 | 15 | 15 | 15 | 15 |
| PMI | — | — | — | 2 | 5 | — | — | — |
| monomer | | | | | | | | |
| Putting | 1^{st} | 1^{st} | 3^{rd} | — | — | — | — | — |
| position | Reactor | Reactor | Reactor | | | | | |
| of | | | | | | | | |
| (E) + (G) | | | | | | | | |
| % by | 10% | 22% | 10% | — | — | — | — | — |
| weight | | | | | | | | |
| of (G) | | | | | | | | |

Physical Properties Measurement

Physical properties of the thermoplastic resin prepared by Examples 1 to 5 and Comparative Examples 1 to 6 are measured by the following methods and the results are presented in the following Tables 2 and 3.

(1) Weight average molecular weight: An elution curve is drawn up by gel-permeation chromatography (GPC, LF-804 column manufactured by Waters Corporation) using THF as a moving phase and relative number average molecular weight, weight average molecular weight and polydispersity index (PDI) are analyzed on the basis of the standard polystyrene polymer.

(2) Izod impact strength (kgfcm/cm, ⅛″ Notched): Izod impact strength is measured according to ASTM 256

(3) Fluidity (220° C., 10 kg): Melt flow index of the samples is measured according to ASTM D-1238.

(4) Vicat softening point (5 kg, 50° C./hr): Vicat softening point of the samples is measured according to ISO R 306.

TABLE 2

| | Example 1 | Example 2 | Example 3 |
|---|---|---|---|
| Temperature of the | 130 | 130 | 130 |
| third reactor (R3) | | | |
| (° C.) | | | |
| Temperature (° C.) of | 160 | 160 | 160 |
| delivering pipe(R3-> | | | |
| the devolatile | | | |
| apparatus) | | | |
| Weight average | 136,100 | 141,100 | 130,700 |
| molecular weight | | | |
| polydisperse index | 2.6 | 19.8 | 20.1 |
| Izod impact | 21.6 | 19.8 | 20.1 |
| strength(kgfcm/cm, | | | |
| ⅛″ Notched) | | | |
| Melt index (220° C., | 4.1 | 3.5 | 4.6 |
| 10 kg) | | | |
| Vicat softening point | 108.1 | 110.3 | 108.0 |
| (5 kg, 50° C./hr) | | | |

TABLE 3

| | Comparative | Comparative | Comparative | Comparative | Comparative |
|---|---|---|---|---|---|
| | Example 1 | Example 2 | Example 3 | Example 4 | Example 5 |
| Temperature of | 130 | 130 | 130 | 130 | 130 |
| the third reactor | | | | | |
| (R3) | | | | | |
| (° C.) | | | | | |
| Temperature | 160 | 160 | 160 | 160 | 160 |
| (° C.) of | | | | | |
| delivering pipe | | | | | |
| (R3-> the | | | | | |
| devolatile | | | | | |
| apparatus) | | | | | |
| Weight average | 130,800 | 139,300 | 148,200 | 132,300 | 113,000 |
| molecular weight | | | | | |
| polydisperse | 2.7 | 2.7 | 2.4 | 2.7 | 2.7 |
| index | | | | | |
| Izod impact | 8.5 | 4.2 | 24.3 | 22.6 | 11.6 |
| strength | | | | | |
| (kgfcm/cm, 1/8″ | | | | | |
| Notched) | | | | | |
| Melt index | 4.2 | 3.1 | 3.6 | 4.3 | 10.4 |
| (220° C., 10 kg) | | | | | |
| Vicat softening | 108.3 | 109.2 | 101.1 | 106.0 | 105.8 |
| point (5 kg, | | | | | |
| 50° C./hr) | | | | | |

The results shown in the above Table 2 and 3 show that high heat resistance can be obtained without reducing physical properties such as impact strength by using the copolymer of N-substituted maleimide compound and aromatic vinyl compound. Moreover, when the second reactant is added during both an initial and middle or latter polymerization, heat resistance is significantly improved. Further, when the second reactant is fed into the first reactor such as in Example 3, weight average molecular weight is reduced as compared to Examples 1 and 2.

On the other hand, when PMI monomer is melted into unsaturated nitrile compound and fed instantly such as in Comparative Examples 1 and 2, impact strength is significantly reduced by reducing miscibility with the existing matrix.

Moreover, Comparative Examples 3 to 5 which control only the amount of the heat resistant aromatic vinyl compound have limited improved heat resistance.

As illustrated by the Examples and Comparative Examples, the thermoplastic resin according to the present invention can have excellent heat resistance and impact strength, and the method of the present invention can improve heat resistance of the thermoplastic resin while maintaining other physical properties. Further, the thermoplastic resin can have an excellent balance of heat resistance and impact strength.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition that can have excellent heat resistance and impact strength comprising a rubber-modified styrene resin and a copolymer of N-substituted maleimide compound and aromatic vinyl compound.

2. The thermoplastic resin composition of claim 1, wherein said thermoplastic resin composition is prepared by adding a solution phase of the copolymer of N-substituted maleimide compound and aromatic vinyl compound during continuous polymerization of the rubber-modified styrene resin.

3. The thermoplastic resin composition of claim 2, wherein the solution phase of said copolymer of N-substituted maleimide compound and aromatic vinyl compound comprises said copolymer melted in an unsaturated nitrile compound.

4. The thermoplastic resin composition of claim 1, wherein said thermoplastic resin composition includes about 1 to about 14.3 parts by weight of the copolymer of N-substituted maleimide compound and aromatic vinyl compound based on about 100 parts by weight of the rubber-modified styrene resin.

5. The thermoplastic resin composition of claim 4, wherein said rubber-modified styrene resin further comprises about 0.005 to about 0.5 parts by weight of a multi-functional vinyl monomer.

6. The thermoplastic resin composition of claim 5, wherein said multi-functional vinyl compound comprises divinylbenzene, ethylene glycol dimethacrylate, allyl methacrylate, diallyl phthalate, diallyl maleate, triallylisocyanurate or a combination thereof.

7. The thermoplastic resin composition of claim 1, wherein said rubber-modified styrene resin comprises a graft copolymer resin prepared by graft copolymerizing an aromatic vinyl monomer and a unsaturated nitrile monomer onto a rubbery polymer, and a copolymer resin prepared by copolymerizing an aromatic vinyl monomer, unsaturated nitrile monomer and heat resistant aromatic vinyl monomer.

8. The thermoplastic resin composition of claim 7, wherein said rubbery polymer comprises a conjugated diene rubber and a rubbery aromatic copolymer.

9. The thermoplastic resin composition of claim 8, wherein said rubbery aromatic copolymer is prepared by copolymerizing about 50 to about 80% by weight of a conjugated diene compound and about 20 to about 50% by weight of an aromatic vinyl compound, and wherein said conjugated diene compound comprises 1,3-butadiene, 2-methyl-1,3-butadiene(isoprene), 2-ethyl-1,3-butadiene, 2,3-dimethyl-1,3-butadiene, 1,3-pentadiene, 3-butyl-1,3-oxtadiene or a combination thereof.

10. The thermoplastic resin composition of claim 6, wherein said rubber-modified styrene resin comprises about 5 to about 20% by weight of the conjugated diene rubber, about 0.5 to about 8% by weight of the rubbery aromatic copolymer, about 15 to about 29% by weight of the heat resistant aromatic vinyl monomer, about 10 to about 50% by weight of the aromatic vinyl monomer and about 10 to about 30% by weight of the unsaturated nitrile monomer.

11. The thermoplastic resin composition of claim 7, wherein said aromatic vinyl monomer comprises α-methyl styrene.

12. The thermoplastic resin composition of claim 1, wherein said copolymer of N-substituted maleimide compound and aromatic vinyl compound is prepared by copolymerizing about 40 to about 60% by weight of the N-substituted maleimide compound and about 40 to about 60% by weight of the aromatic vinyl compound.

13. The thermoplastic resin composition of claim 3, wherein said thermoplastic resin has a weight average molecular weight of about 100,000 to about 150,000.

14. The thermoplastic resin composition of claim 1, wherein said thermoplastic resin has a polydispersity index of about 2 to about 4.

15. The thermoplastic resin composition of claim 1, wherein said thermoplastic resin has a Izod impact strength (kgf·cm/cm, ⅛″ Notched) measured according to ASTM D256 of about 15 to about 35, a melt flow index (220° C., 10 kg) measured according to ASTM D1238 of about 3 to about 7, and a vicat softening temperature (5 kg, 50° C./hr) measured according to ISO R 306 of about 107 to about 115° C.

16. A method of preparing a thermoplastic resin composition that can have excellent heat resist and impact strength comprising:
continuously feeding a first feed stream including a first reactant comprising a conjugated diene rubber, an aromatic rubbery copolymer, a heat resistant aromatic vinyl compound, an aromatic vinyl compound, a multi-functional vinyl compound and an initiator and a second feed stream that is different from the first feed stream including a second reactant comprising an unsaturated nitrile compound, a N-substituted maleimide compound and an aromatic vinyl compound to a reactor that is part of a plurality of reactors linked in series; and
thereafter polymerizing the first reactant and the second reactant to prepare a polymer.

17. The method of 16, wherein the temperature of each of said reactors is maintained at about 90 to about 150° C.

18. The method of 16, wherein the plurality of reactors includes a final polymerization reactor, and wherein the final polymerization reactor is maintained at a temperature of about 110 to about 140° C.

19. The method of 16, further comprising delivering a polymer from the final polymerization reactor to a devolatizer apparatus and removing volatile components of the polymer.

20. The method of 19, wherein the polymer delivered from the final polymerization reactor to the devolatizer at a temperature of about 140 to about 160° C.

21. The method of 19, wherein said devolatizer apparatus is operated under the conditions of a temperature of about 230 to about 260° C. and a pressure of about 100 torr or less.

22. The method of 16, wherein the number of the plurality of reactors is about 2 to about 5.

23. The method of 16, wherein the first reactant and the second reactant are fed into the same reactor and polymerized.

24. The method of 16, wherein the first reactant is fed into a first reactor and polymerization thereof is initiated in the first reactor to form a polymer, the second reactant is fed into a downstream reactor, the polymer from the first reactor is directed into the downstream reactor, and the second reactant participates in additional polymerization of the polymer in the downstream reactor.

25. The method of 16, wherein said first reactant further comprises an organic solvent.
